(19) United States
(12) Patent Application Publication
(10) Pub. No.: US 2016/0357077 A1
(43) Pub. Date: Dec. 8, 2016

(54) LIQUID CRYSTAL OPTICAL DEVICE

(71) Applicant: Asahi Glass Company, Limited, Chiyoda-ku (JP)

(72) Inventors: Satoshi NIIYAMA, Chiyoda-ku (JP); Remi KAWAKAMI, Chiyoda-ku (JP)

(73) Assignee: Asahi Glass Company, Limited, Chiyoda-ku (JP)

(21) Appl. No.: 15/161,356

(22) Filed: May 23, 2016

(30) Foreign Application Priority Data
Jun. 5, 2015 (JP) 2015-115208

(51) Int. Cl. G02F 1/1343; G02F 1/1337; G02F 1/137

(52) U.S. Cl. CPC G02F 1/134363; G02F 1/137; G02F 1/133711; G02F 2001/13706; G02F 2001/133742

(57) ABSTRACT

To provide a liquid crystal optical device which has high quality even when it is large-sized, and which can operate at low power consumption.

A liquid crystal optical device 100 comprising a pair of substrates 10, 20 facing each other, at least one of which having transparency to light, an electrooptical functional layer sandwiched between the substrates, and an electric field applying means to generate an electric field in the electrooptical functional layer, wherein the electrooptical functional layer contains a liquid crystal compound having a positive dielectric anisotropy and showing liquid crystallinity, and an alignment-controlling material for controlling the alignment of the liquid crystal compound, and the electric field applying means is so constituted as to generate an electric field containing lines of electric force substantially in parallel with the substrate surface of at least one of the substrates.

### FIELD OF INVENTION

The present invention relates to a liquid crystal optical device comprising an electrooptical functional layer containing a liquid crystal compound and an alignment-controlling material.

### BACKGROUND OF INVENTION

Liquid crystal optical devices have merits such as low power consumption, small thickness or light weight, and they are widely used for many electronic devices such as cellphones, digital cameras, portable information devices or TVs. Among these, in recent years, liquid crystal optical devices are proposed, in which electric field is controlled to control alignment of liquid crystal molecules thereby to change a light-scattering state.

Patent Document 1 discloses a liquid crystal optical device such that a polyimide thin film for vertical alignment is formed on a pair of substrates provided with an electrode, a mixture of a liquid crystal and an uncured curable compound is sandwiched between the substrates, and the curable compound is cured by light exposure in a state where the mixture shows a liquid crystal phase to form a liquid crystal/curable composite layer. Further, Patent Document 2 discloses a liquid crystal optical device having an electrooptical functional layer containing a liquid crystal and a polymer, obtained in such a manner that a liquid crystalline mixture containing a specific bifunctional polymerizable compound and a specific non-polymerizable liquid crystal composition is sandwiched between a pair of substrates provided with an electrode, and the polymerizable compound is polymerized to form a polymer in a state where the mixture shows a liquid crystal phase.

A liquid crystal optical device using a liquid crystal polymer composite of a transmission/scattering operation mode employs a system such that the liquid crystal polymer composite is sandwiched between a pair of substrates provided with an electrode, and a voltage is applied to the electrodes to change optical properties of the liquid crystal, and such a device is also called a polymer dispersed liquid crystal device or a dispersed liquid crystal. Unlike a conventional TN mode liquid crystal optical device or the like, the transmission/scattering liquid crystal optical device does not require a polarizing plate in principle, and accordingly its absorption loss of light is small, it has high scattering properties, and its light utilization efficiency is high as a whole. By making use of such properties, it is used for light control glass, an optical shutter, laser equipment, a display device, etc.

### PRIOR ART DOCUMENTS

### Patent Documents

Patent Document 1: JP-A-2000-119656

Patent Document 2: JP-A-2005-202391

### SUMMARY OF INVENTION

### Technical Problem

The motive power to drive the transmission/scattering mode liquid crystal is the electric field strength. This electric field strength is inversely proportional to the cell gap, and accordingly, even when an electric field of the same strength is applied, the electric field strength varies 10 times between a case where the cell gap is 1 μm and a case where it is 10 μm. If the cell gap is different, the optical properties and the response speed at the time of voltage application/non-application vary depending upon the region. Accordingly, it is important to maintain the cell gap to be constant in one device. However, as the substrate size becomes large, it tends to be difficult to maintain the cell gap to be constant. Further, in a case where curved substrates are used as a pair of substrates, it is difficult to make the curvatures of the substrates completely agree with each other to maintain the cell gap to be constant.

In the above, problems in a transmission/scattering mode liquid crystal optical device have been described, however, the same problems may arise in a liquid crystal optical device of a mode such that optical properties such as the refractive index are changed by application/non-application of a voltage to conduct optical modulation.

The present invention has been accomplished under these circumstances, and its object is to provide a high quality liquid crystal optical device regardless of the area and the shape of the substrates.

### Solution to Problem

The present invention provides a liquid crystal optical device having constructions of the following [1] to [8].
[1] A liquid crystal optical device comprising:

a pair of substrates facing each other, at least one of which having transparency to light,

an electrooptical functional layer sandwiched between the substrates, and

an electric field applying means to generate an electric field in the electrooptical functional layer,

wherein the electrooptical functional layer contains a liquid crystal compound having a positive dielectric anisotropy and showing liquid crystallinity, and an alignment-controlling material for controlling the alignment of the liquid crystal compound, and

the electric field applying means is so constituted as to generate an electric field containing lines of electric force substantially in parallel with the substrate surface of at least one of the substrates.
[2] The liquid crystal optical device according to [1], which is in a transparent state when no voltage is applied and in a state where incident light is scattered when a voltage is applied.
[3] The liquid crystal optical device according to [1] or [2], wherein the alignment-controlling material comprises a polymer structure.
[4] The liquid crystal optical device according to any one of [1] to [3], wherein the electric filed applying means comprises a first electrode and a second electrode formed on at least one of the substrates, and generates the above electric field by applying a voltage between the first and second electrodes.
[5] The liquid crystal optical device according to [4], wherein each of the first electrode and the second electrode has a plurality of electrode pairs in parallel with each other, and the electrode pairs of the first electrode and the electrode pairs of the second electrode are alternately disposed so that they are in parallel with the substrate surface of the substrate.
[6] The liquid crystal optical device according to any one of [1] to [5], wherein the average direction of long axes of molecules of the liquid crystal compound substantially agrees with the normal direction of the substrate surface of at least one of the substrates when no voltage is applied.
[7] The liquid crystal optical device according to any one of [1] to [6], wherein the alignment-controlling material is a polymer structure containing resin columns at least some of which extend in the normal direction of the substrate surface.
[8] The liquid crystal optical device according to any one of [1] to [7], wherein an alignment functional layer is formed on the outer side of the electrooptical functional layer, and the alignment functional layer is a vertical alignment functional layer.

### Advantageous Effects of Invention

According to the present invention, it is possible to provide a high quality liquid crystal optical device regardless of the substrate area.

### BRIEF DESCRIPTION OF DRAWINGS

FIG. 1 is a view schematically illustrating a substantial part of a liquid crystal optical device according to an embodiment of the present invention when no voltage is applied.

FIG. 2 is a plan view schematically illustrating the structure of a voltage applying means according to an embodiment of the present invention.

FIG. 3 is a view schematically illustrating a substantial part of a liquid crystal optical device according to an embodiment of the present invention when a voltage is applied.

FIG. 4 is a view illustrating an example of lines of electric force of a liquid crystal optical device according to an embodiment of the present invention when a voltage is applied.

### DETAILED DESCRIPTION OF INVENTION

The liquid crystal optical device of the present invention is capable of reversibly controlling the optical modulation by application of a driving voltage. For optical modulation, there are a mode such that the light transmission state and the light scattering state are reversibly controlled by application or non-application of a driving voltage, and a mode such that optical properties such as the refractive index are reversibly controlled in accordance with application of a driving voltage. Such optical modulation is usually applicable to visible light, however, light rays in a band other than the visible light (hereinafter referred to as another band) may be utilized depending upon the purpose of use. Now, an embodiment of the present invention will be described. Needless to say, other embodiments fall into the category of the present invention so long as they are within the range of the present invention. The sizes and the proportions of the members in drawings are for convenience in illustration and are different from actual ones.

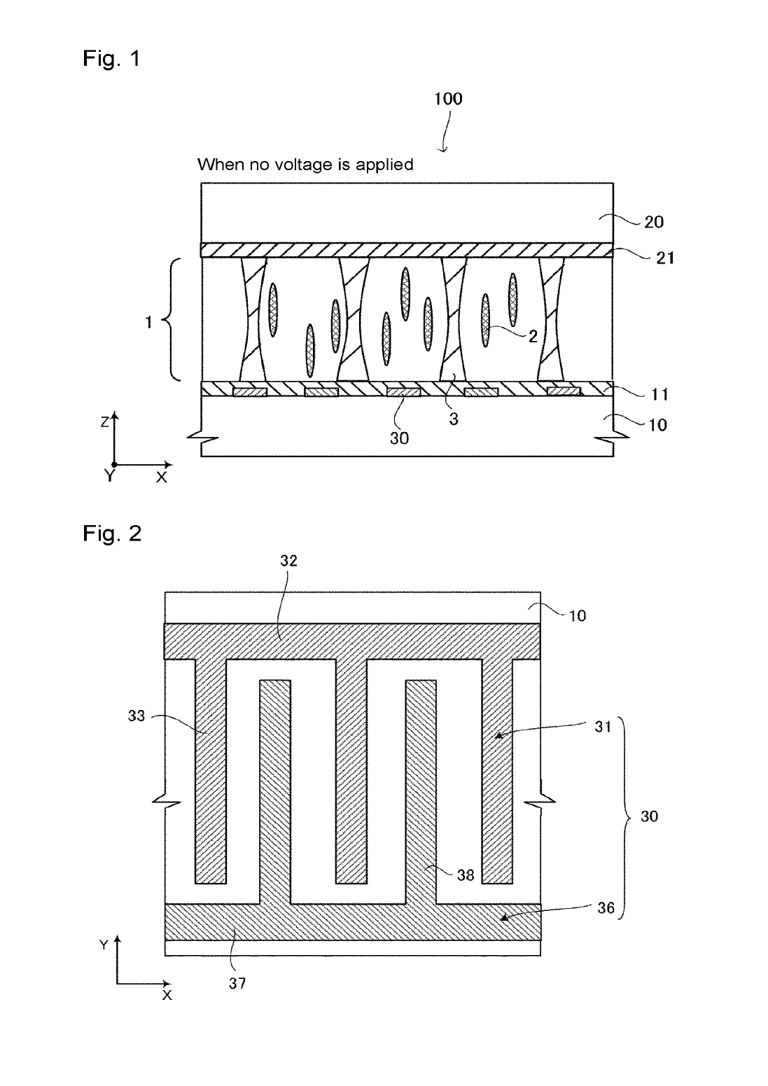

In this embodiment, an example of a liquid crystal optical device in a light transmission state when no voltage is applied and in a state where incident light is scattered when a voltage is applied, will be described. FIG. 1 is a view schematically illustrating a substantial part of an example of the liquid crystal optical device according to this embodiment. FIG. 1 illustrates a state where no voltage is applied. A liquid crystal optical device 100 according to this embodiment comprises a planner first substrate 10 and a planner second substrate 20 disposed to face each other at a certain interval.

On a surface facing the second substrate 20 of the first substrate 10, an electric field applying means 30 is formed, and a first alignment functional layer 11 is formed so as to cover the electric field applying means 30. Further, on a surface facing the first substrate 10 of the second substrate 20, a second alignment functional layer 21 is formed. A spacer (not shown) is provided to maintain a prescribed interval between the first substrate 10 and the second substrate 20, a peripheral seal (not shown) is formed at the outer peripheral edge portion between the first substrate 10 and the second substrate 20, and the substrates are bonded by the peripheral seal. And, an electrooptical functional layer 1 is sealed in a space surrounded by the first substrate 10, the second substrate 20 and the peripheral seal. It is preferred to form an insulating layer between the electric field applying means and the alignment functional layer, whereby short-circuiting when a current is applied can be suppressed in a case where an electrically conductive foreign matter is included between the first substrate 10 and the second substrate 20.

At least one of the first substrate 10 and the second substrate 20 is a transparent substrate transparent to visible light. Both the first substrate 10 and the second substrate 20 may be a transparent substrate, or they may be a substrate transparent to light in another band depending upon the purpose of use. For the first substrate 10 and the second substrate 20, for example, a transparent glass substrate or resin substrate such as a polyester film, or a substrate made of a combination thereof, may be used. The first substrate 10 and the second substrate 20 are not necessarily substrates made of the same material, and various substrates such as a reflecting substrate and a semi-transmissive half mirror substrate may be used depending upon the purpose of use.

The electric field applying means 30 has a role to generate an electric field in the electrooptical functional layer 1. It should generate an electric field having lines of electric force in a direction in parallel with the substrate surface of at least one of the substrates. In this embodiment, a pectinate first electrode 31 and a pectinate second electrode 36 are formed as the electric field applying means 30 on a main surface on which the electrooptical functional layer 1 is disposed of the first substrate 10, as shown in the schematic plan view of FIG. 2.

The first electrode 31 has, as shown in FIG. 2, a line-shape connecting portion 32 extending in the X direction in the vicinity of one side of the first substrate 10, and a plurality of line-shape pectinate portions 33 extending in the Y direction from the connecting portion 32 toward an opposing side. The second electrode 36 has a line-shape connecting portion 37 extending in the X direction in the vicinity of a side opposing the connecting portion 32 of the first electrode 31, and a plurality of line-shape pectinate portions 38 extending in the Y-direction from the connecting portion 37 toward the opposing connecting portion 32. The pectinate portions 33 and 38 are alternately disposed in parallel with each other. The pectinate portions 33 and 38 form electrode pairs to generate an electric field in the electrooptical functional layer 1.

It is preferred to use a transparent electrically conductive film for the first electrode 31 and the second electrode 32. The transparent electrically conductive film may, for example, be a film of a metal oxide such as ITO (indium tin oxide) or tin oxide. A glass provided with a transparent electrically conductive film comprising a glass substrate as the first substrate 10 or the second substrate 20 and a pattern of a metal oxide such as ITO formed as the first electrode 31 or the second electrode 36, a polyester film provided with a transparent electrically conductive film comprising polyethylene terephthalate (PET) and an ITO film formed thereon, or a PES (polyether sulfone) provided with a transparent electrically conductive film may, for example, be used. Instead of the transparent electrically conductive film, an electrode by narrow lines of a metal film, or an electrode by nanoimprint or by drawing using an electrically conductive ink containing metal nanowires or nanoparticles may be employed.

The electrooptical functional layer 1 contains a compound having a positive dielectric anisotropy and showing liquid crystallinity (hereinafter referred to as a liquid crystal compound) 2 and an alignment-controlling material 3 for controlling alignment of the liquid crystal compound 2. In FIG. 1, for convenience in illustration, several molecules of the liquid crystal compound 2 are shown, however, in practice, a region where the alignment-controlling material is not formed is filled with the liquid crystal compound 2.

The value of the dielectric constant ε_{A} in the long axis direction of the liquid crystal compound 2 is larger than the value of the dielectric constant ε_{B} in the short axis direction of the compound, and the value of Δε=ε_{A}−ε_{B} is positive. The liquid crystal compound is usually used in an environment in which it shows a liquid crystal phase, however, use in an isotropic phase is not excluded.

As the type of the liquid crystal, nematic liquid crystal, cholesteric liquid crystal, smectic liquid crystal, ferroelectric liquid crystal, etc. may be used. Preferred is nematic liquid crystal in view of a wide operating temperature range and a high operating speed.

As the liquid crystal compound 2, various common display materials or materials used as a material of an electric field drive display device may be used. Specifically, a biphenyl, phenyl benzoate, cyclohexylbenzene, azoxybenzene, azobenzene, azomethine, terphenyl, biphenyl banzoate, cyclohexyl biphenyl, phenyl pyridine, cyclohexyl pyrimidine or cholesterol type material may, for example, be mentioned.

The liquid crystal compound 2 may not necessarily be used alone, and may be used in combination of two or more types, in the same manner as general use. Further, in order to lower the driving voltage, it is preferred to use one with a large absolute value of the dielectric anisotropy. As a liquid crystal compound with a large absolute value of the dielectric anisotropy, a compound having a cyano group or a halogen atom such as fluorine or chlorine as a substituent is used in view of chemical stability. A compound having a cyano group as a substituent is used when a decrease in the driving voltage is emphasized, and a compound having a fluorine atom as a substituent is used when the reliability is emphasized.

In the electrooptical functional layer 1, various compounds may be incorporated for the purpose of improving the contrast ratio and the stability. For example, for the purpose of improving the contrast, a dichroic dye such as an anthraquinone, styryl, azomethine or azo type dye may be used. In such a case, the dichroic dye is preferably basically compatible with the liquid crystal compound and incompatible with a polymer compound. In addition, an antioxidant, an ultraviolet absorber and a plasticizer may also be preferably used in view of improvement in the stability and the durability.

The alignment-controlling material 3 has a role to control the liquid crystal compound 2 so that the long axes of molecules of the liquid crystal compound 2 are aligned substantially in one direction in the electrooptical functional layer 1 when no voltage is applied. Here, alignment “substantially in one direction” includes alignment of the liquid crystal compound in such a level that the liquid crystal compound has an ordered structure of the optical wavelength or less and the transparency can be maintained. Further, the alignment-controlling material 3 has a role to change the long axis directions of molecules of the liquid crystal compound in a plurality of directions different from the direction controlled when no voltage is applied, by the electric field and the alignment-controlling material 3, when a voltage is applied. When an electric field is generated in the electrooptical functional layer 1 by the electric field applying means 30, at least part of molecules of the liquid crystal compound 2 are changed in directions different from the direction controlled by the alignment-controlling material 3, whereby optical modulation is conducted by switching between voltage application and voltage non-application. In this embodiment, the transmission state is changed to the scattering state by switching between voltage application and voltage non-application.

The principle how the transmission state is changed to the scattering state by switching between voltage application and voltage non-application is not clearly understood but is considered as follows.

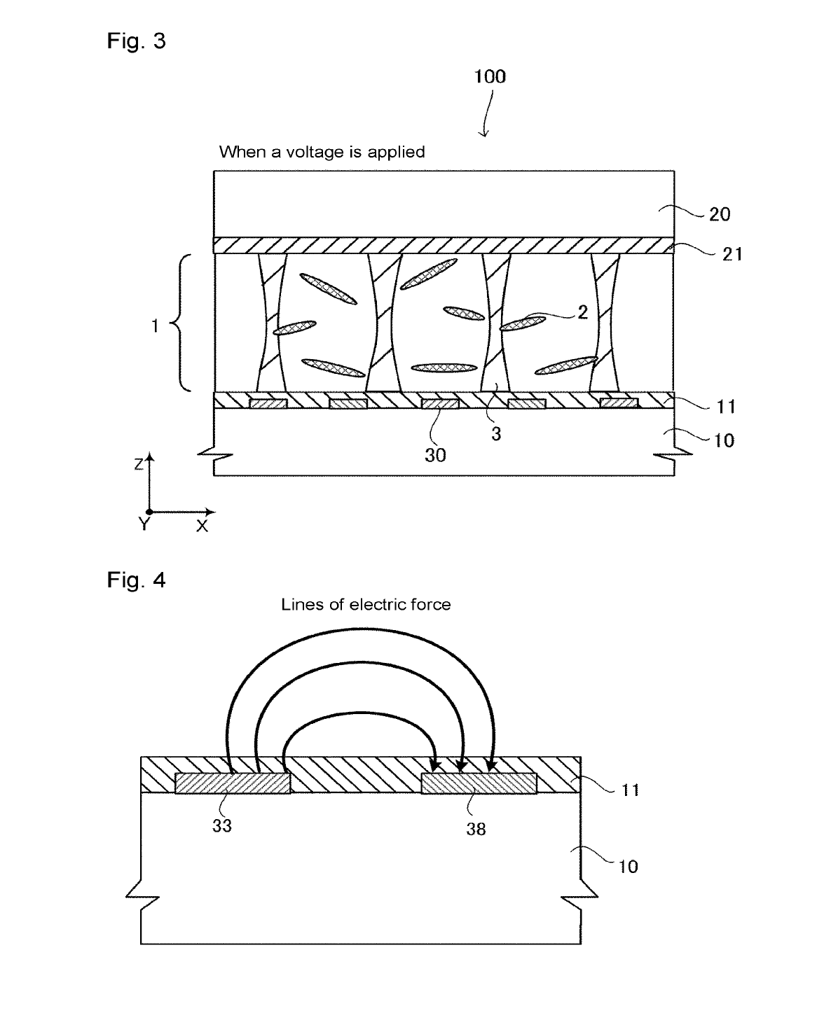

In FIG. 3, a drawing schematically illustrating a substantial part of the liquid crystal optical device 100 according to this embodiment when a voltage is applied is shown. When a voltage is applied, as shown in FIG. 4, an electric field containing lines of electric force in a direction in parallel with the substrate surface is generated, and molecules of the liquid crystal compound 2 are to move so that the long axes agree with the direction of the lines of electric force. On that occasion, the molecules of the liquid crystal compound 2 in the vicinity of the alignment-controlling material 3 are prevented from moving so that the long axes agree with the direction of the lines of electric force by the alignment-controlling material 3, and they are in directions different from the lines of electric force. That is, by using the alignment-controlling material 3, not all the molecules of the liquid crystal compound 2 are aligned so that the long axes are in a direction which agrees with the lines of electric force when a voltage is applied, and the long axes of the liquid crystal compound 2 are in a plurality of directions. As a result, the ordered structure is disturbed, and the liquid crystal compound shows a scattering state. The directions of the long axes of the liquid crystal molecules in FIG. 3 are for convenience in illustration, and in practice, the average direction (director) of the long axes of the liquid crystal molecules in the liquid crystal molecule aggregate (domain) aligning is not in parallel with the substrate surface since alignment is disturbed by the alignment-controlling material 3 having a complicated shape, and the liquid crystal molecules are aligned multidirectionally with a vector component in a parallel direction.

The average direction of the long axes of the liquid crystal molecules preferably substantially agree with the normal direction of the substrate surface of at least one of the substrates when no voltage is applied. And, when a voltage is applied, the long axes of the liquid crystal molecules are aligned in a plurality of directions including a direction component in parallel with the substrate surface of at least one of the substrates.

As a preferred example of the alignment-controlling material 3, a columnar polymer structure, a network polymer structure or a porous inorganic structure may be mentioned. The alignment-controlling material 3 may be provided as discrete in the electrooptical functional layer 1 as spacers, or may be so constituted as to completely break the domain of the liquid crystal phase as partition walls or as a honeycomb. Otherwise, it may have a structure formed in a film or in a network on the outermost surface of the substrate or a combination thereof. In this embodiment, a columnar polymer structure is employed as the alignment-controlling material 3.

The polymer structure contained in the electrooptical functional layer 1 according to this embodiment is an aggregate of a plurality of resin columns. The resin columns are preferably a mixture of resin columns the long axis directions of which substantially agree with the normal direction of the surface of the substrate provided with an electrode, and resin columns tilted from the normal direction. The resin columns tilted from the normal direction mean resin columns the long axis directions of which are tilted based on the normal of the substrate surface.

With a view to increasing the impact resistance, the polymer structure in the electrooptical functional layer 1 preferably has a plurality of aggregates of the resin columns, and each of the aggregates of the resin columns has an axis center which substantially agrees with the normal direction of the surface of the substrate provided with an electrode, and the area occupied by the resin columns in the electrooptical functional layer in a plane horizontal to the surface of the substrate with an electrode becomes small as the plane is apart from the substrate with an electrode.

Further, with a view to improving the impact resistance, it is preferred to form the domain region of the liquid crystal so that the aggregates of the resin columns are connected. Here, the liquid crystal domain region means a space occupied by the liquid crystal molecules. The resin columns may or may not chemically or physically adhere to the substrate surface formed by e.g. an alignment film.

The first alignment functional layer 11 and the second alignment functional layer 21 are formed respectively on the first substrate 10 and the second substrate 20, are in contact with the electrooptical functional layer 1, and have a role to align a precursor of the polymer structure which is the alignment-controlling material 3 in the electrooptical functional layer 1 in a desired direction during production. In other words, the first alignment functional layer 11 and the second alignment functional layer 21 are formed on the outer sides of the electrooptical functional layer 1. On the first alignment functional layer 11 and the second alignment functional layer 21, a layer of the polymer structure is formed substantially entirely. The material of each of the first alignment functional layer 11 and the second alignment functional layer 21 is not particularly limited, and for example, a polyimide, a silane compound having an alkyl group or a fluoroalkyl group, or an olefin compound may be mentioned. From the viewpoint of heat resistance and stiffness, a polyimide is preferred. Such alignment functional layers may be formed, for example, by a rubbing treatment or a photo-alignment method on a thin film. In order to form resin columns in the normal direction on the substrate surface, a method of using a vertical alignment functional layer as the first alignment functional layer 11 and the second alignment functional layer 21 is simple, and by such a method, no rubbing treatment is necessary. In this embodiment, so long as the alignment-controlling material 3 is formed, the first alignment functional layer 11 and the second alignment functional layer 21 are not necessarily formed.

The spacer has a role to define the thickness of the liquid crystal cell. The thickness of the electrooptical functional layer 1 sandwiched between the substrates is defined by the spacer. As the spacer, for example, glass particles, resin particles, alumina particles, glass fibers or a film may be used. As the shape of the spacer, a spherical spacer, a fibrous spacer or a columnar spacer may, for example, be mentioned. A wall-shape or rectangular spacer may be provided by means of photolithography.

The thickness of the electrooptical functional layer 1 is usually from 1 to 50 μm, preferably from 3 to 30 μm. If the interval between the substrates is too short, the contrast will decrease, and if the interval is too long, the driving voltage may increase.

Now, an example of a method for producing the electrooptical functional layer according to this embodiment will be described. However, the present invention is by no means restricted to the following production method.

The electrooptical functional layer 1 may be formed from a mixed liquid of a precursor of the electrooptical functional layer (hereinafter sometimes referred to simply as “a mixed liquid”). It is important to form a favorable electrooptical functional layer 1 which can optically function, via the process of phase separation. In a case where the phase separation is insufficient, drawbacks may occur such that the driving voltage to operate the liquid crystal increases, or the liquid crystal optical device does not work. A phase separation structure means a structure in the interior of the liquid crystal cell formed via the phase separation process, which develops electrooptical properties/function.

The fine shape of the phase separation structure of the electrooptical functional layer 1 may be changed e.g. the type, the properties or the mixture ratio of compounds constituting the mixed liquid of the precursor. The combination and the mixture ratio of materials to be used are determined considering optical properties such as transmission/scattering properties, the degree of the driving voltage, the degree of reliability required as an electrooptic device. The mixed liquid of the precursor of the electrooptical functional layer 1 is not particularly limited so long as the above electrooptical functional layer 1 is obtained, however, it contains the liquid crystal compound and a polymerizable compound. In order to obtain a high quality electrooptical functional layer 1 having uniform electrooptical properties of transmission/scattering, it is preferred to properly select the type and the mixture ratio of materials to be used so that the uniform electrooptical functional layer is obtained from the mixed liquid of the precursor.

As a preferred mixed liquid of the precursor of the electrooptical functional layer 1, for example, a mixed liquid containing a liquid crystal compound <C> and a first polymerizable compound <A> and as the case requires, a polymerization initiator, may be used. The first polymerizable compound <A> is selected so that when a composition containing it, the liquid crystal compound <C> and the polymerization initiator is injected between the substrates and polymerized by a method described hereinafter, a polymer obtained by polymerization forms resin columns substantially vertical to the normal direction of the substrate surface. An example of a preferred first polymerizable compound <A> is represented by chemical formula (1). In the mixed liquid, a second polymerizable compound <B> may be incorporated, and such a compound is selected so that a composition containing it is injected between the substrates and polymerized by a method described hereinafter, resin columns are formed randomly. An example of a preferred second polymerizable compound <B> is represented by chemical formula (2).

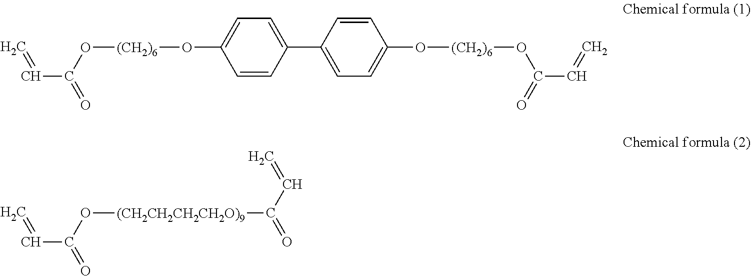

The liquid crystal compound <C> is preferably a non-polymerizable liquid crystal compound. Each of the first polymerizable compound <A> and the second polymerizable compound <B> may be used alone or in combination of two or more. The polymer formed by polymerization may be a copolymer such as a random copolymer or an alternating copolymer, or may be a homopolymer. Considering the uniformity of the polymer in the electrooptical functional layer, a copolymer is preferred. Although the first polymerizable compound <A> may be used alone, by using the first polymerizable compound <A> and the second polymerizable compound <B>, a polymer in which both resin columns which substantially agree with the normal direction of the substrate surface and tilted resin columns are present, can be obtained.

In a case where the first substrate 10 and the second substrate 20 are a film substrate, the first substrate 10 provided with an electrode and the second substrate 20 continuously supplied are sandwiched between two rubber rollers or the like, and between the substrates, a liquid having a spacer dispersed in the mixed liquid is supplied and sandwiched between the substrates, followed by continuous polymerization, and high productivity is thereby achieved.

In a case where the first substrate 10 and the second substrate 20 are a glass substrate, a very small amount of a spacer is spread on their surface, four sides of the facing substrates are sealed by a sealing agent such as an epoxy resin to form a sealed cell, at least two cutouts are provided in the seal, one of the cutouts is dipped in the mixed liquid and the mixed liquid is sucked through another cutout, whereby the liquid crystal cell is filled with the mixed liquid, and the mixed liquid is polymerized. In the case of a relatively small cell, a cell having at least one cutout in the seal can be filled with the mixed liquid without bubbles by a vacuum injection method. In a case where a large cell is to be prepared, the mixed liquid is applied by a dispenser or an inkjet head to the inner side of a curable sealing material provided at the periphery of one of the first substrate 10 and the second substrate 20, and the other substrate is laminated in a reduced pressure atmosphere and bonded by means of the sealing material at the periphery, and then the pressure is recovered to an atmospheric pressure, and the peripheral sealing material is cured e.g. by UV light (ODF method).

First, the first electrode 31 and the second electrode 36, the first alignment functional layer 11, the second alignment functional layer 21, and the like are formed on the first substrate 10 and the second substrate 20. After the alignment film is baked, an alignment treatment such as rubbing is carried out as the case requires. Then, on the alignment film-formed side of the first substrate 10, a spacer is spread by a spreader. On the second substrate 20, a sealing material is applied. The first substrate 10 and the second substrate 20 are positioned by e.g. alignment marks, and contact-bonded by heating. The space between substrates after contact-bonding is kept by the spacer.

Then, the mixed liquid to be the precursor of the electrooptical functional layer 1 is injected between the substrates and sealed. As a sealing method, a known method may be used.

Then, an external stimulus is applied to the mixed liquid of the precursor of the electrooptical functional layer 1 to form the electrooptical functional layer 1. The external stimulus may, for example, be irradiation with light such as visible light rays, ultraviolet rays or electron beams, or heat. Particularly, with a view to readily controlling the temperature at the time of polymerization, irradiation with light is preferred. More preferred is irradiation with ultraviolet rays in view of handling efficiency, easiness of production, etc.

In the case of a so-called photopolymerization phase separation method in which the mixed liquid of the precursor of the electrooptical functional layer 1 is subjected to phase separation by photopolymerization to obtain the electrooptical functional layer 1, as a light source, a high pressure mercury lamp, a low pressure mercury lamp, a metal halide lamp, a chemical lamp or an LED lamp may, for example, be used.

In a case where the mixed liquid of the precursor of the electrooptical functional layer 1 is irradiated with light for polymerization, the light irradiation conditions are determined in accordance with the type of the polymerizable monomer. In a case where the mixed liquid is directly irradiated, the intensity of the light is preferably from 0.1 to 400 mW/cm². If it is less than 0.1 mW/cm², the phase separation rate tends to be low and the scattering intensity tends to decrease, and if it exceeds 400 mW/cm², a decomposition reaction may occur by a photoreaction, and the retention may decrease.

The temperature at the time of light irradiation is preferably within a temperature range within which the mixed liquid can show a liquid crystal phase. If polymerization is conducted at a compatible temperature at which the mixed liquid shows a compatible state or lower, phase separation may occur before photopolymerization is conducted, and a liquid crystal polymer composite in which the liquid crystal is in a non-uniform state may form. Further, if the temperature of the mixed liquid is too high, the mixed liquid may undergo phase transition from a liquid crystal phase to an isotropic phase, and scattering/transmission electrooptical properties of a liquid crystal optical device may not be secured. In order for polymerization under uniform conditions (light irradiation and polymerization temperature) over the entire surface of the liquid crystal optical device 100, polymerization is preferably carried out in a constant environment using a temperature controlling device such as a constant temperature chamber or a fan.

The polymerization initiator may be properly selected from known polymerization catalysts, and in the case of photopolymerization, a photopolymerization initiator commonly used for photopolymerization, such as a benzoin ether type, an acetophenone type or a phosphine oxide type may be used. In the case of thermal polymerization, a thermal polymerization initiator such as a peroxide type, a thiol type, an amine type or an acid anhydride type may be used depending upon the type of the polymerization moiety, and a curing aid such as an amine type may be used as the case requires.

The content of the polymerization initiator is usually from 0.1 to 20 parts by mass, preferably from 0.1 to 10 parts by mass per 100 parts by mass of the total amount of the polymerizable monomers. In a case where a polymer (polymerized product) after polymerization is required to have a high molecular weight or a high specific resistance, the content is more preferably from 0.1 to 5 parts by mass. If the content of the polymerization initiator exceeds 20 parts by mass, compatibility of the mixed liquid tends to be deteriorated.

Further, if the content of the polymerization initiator is less than 0.1 part by mass, the polymerizable monomers contained in the mixed liquid may not sufficiently be polymerized, and no desired phase separation structure will be formed. Accordingly, the content of the polymerization initiator is preferably within the above range. Further, a known chiral agent may be added to the mixed liquid so as to improve the contrast ratio of the liquid crystal optical device at the time of electric field application/non-application, or a dichroic dye or a common dye, a pigment or the like may be added so as to control the color tone of the liquid crystal optical device at the time of electric field application/non-application.

In the liquid crystal optical device according to this embodiment, an electric field containing lines of electric force substantially in parallel with the substrate surface of at least one of the substrates is generated. That is, the electric field strength is not influenced by the distance between the substrates since the electric filed applying means to generate an electric field including a horizontal electric field is used. In a case where a longitudinal electric field is applied to a pair of substrates provided with an electrode as disclosed in e.g. Patent Document 1 or 2, in order to obtain a high quality liquid crystal optical device, it is necessary to maintain a constant cell gap, since the electric field strength is significantly changed by the cell gap. Whereas, according to this embodiment, it is not necessary to form electrodes on both substrates, and an electric field applying means can be provided on one of substrates, and accordingly a large margin in a thickness direction can be left. Thus, even a glass substrate provided with an electrode, which is relatively thick, or which is not insufficient in plane smoothness, can be used, and particularly a large size liquid crystal optical device will readily be produced. In a case where electrode pairs are formed on one of the substrates, a pattern can be formed e.g. by photolithography, printing or imprint, and accordingly the same pattern of electrode pairs can be formed regardless of the substrate area.

Further, since a liquid crystal compound having a positive dielectric anisotropy is used, the absolute value of Δε can be made large. Accordingly, it is possible to lower the driving voltage, and electric power saving can be achieved.

Now, a modified example of the above embodiment will be described, however, the present invention is by no means restricted thereto.

As a pair of substrates facing each other, instead of two plane substrates, a pair of a plane substrate and a curved substrate may be formed, a pair of two substrates each having a curved portion and a plane portion may be formed, or a pair of two curved substrates may be formed. Otherwise, a polyhedral substrate may be used. In the liquid crystal optical device according to the present invention, an electric field containing lines of electric force substantially in parallel with the substrate surface of at least one of substrates is generated, and accordingly a high quality liquid crystal optical device can be provided even without keeping a constant cell gap as in the above Patent Document 1 or 2, or the like.

In the above embodiment, as an electric field applying means, a pectinate first electrode 31 and a pectinate second electrode 36 are used, however, instead of such electrodes, a pectinate electrode may be formed as one electrode, and a plane electrode as the other electrode may be provided below the pectinate electrode, on the same substrate. Further, a slit electrode may be formed as one electrode, and a plane electrode as the other electrode may be provided below the slit electrode.

In the above embodiment, a constitution such that no electrode is provided on the second electrode 20 is employed, however, a third electrode may be provided on the second substrate, so that a longitudinal electric field can be generated in addition to the horizontal electric field, by applying an electric field between the first electrode and the third electrode, between the second and the third electrode, or between the first electrode, and the second and third electrodes at the same potential. By such a constitution, in the transmission/scattering mode according to the above embodiment, it is possible to increase the response speed into a transparent state or to form a liquid crystal/curable compound by polymerization in a state where the liquid crystal is aligned by an external electric field, and it is not necessary to provide an alignment functional layer to the electrode substrate. Further, a longitudinal electric field may be applied when the liquid crystal molecules are to be recovered to an initial state where no voltage is applied.

In the above embodiment, a liquid crystal optical device having a transmission/scattering mode has been described, and the above embodiment may be applied to a liquid crystal optical device of which optical properties such as the refractive index are changed. Further, by using a TFT substrate as the first substrate, it is possible to control the transmission/scattering mode with respect to each pixel. In such a case, as an electric field applying means, a pixel electrode (first electrode), a counter electrode (second electrode), a switching element, a wiring to supply signals to the switching element, etc. are formed below the first alignment functional layer. Further, it is possible to impart colors by using a color filter substrate as the second substrate.

In the above embodiment, an alignment-controlling material is used as a means for controlling the alignment of the liquid crystal molecules, however, an alignment-controlling material and an alignment functional layer may be used in combination to control the alignment of the liquid crystal molecules.

The liquid crystal optical device of the present invention can control transmission/scattering by application/non-application of a voltage, and is thereby suitably applied to a liquid crystal optical shutter, a liquid crystal light control device, a transparent display, etc. Further, it can control the optical state by application/non-application of a voltage, and is thereby useful as an optical modulation device. Further, it is also useful for a show window, a bulletin board, an instrument panel of an automobile, etc. which shows characters or patterns.

### EXAMPLES

Now, the present invention will be described in further detail with reference to Examples. However, it should be understood that the present invention is by no means restricted to such specific Examples.

### EXAMPLE

90 mass % of a nematic liquid crystal (Tc: 92° C., Δn: 0.228, Δε: 17.9) having a positive dielectric anisotropy and 10 mass % of a curable compound 1 (precursor to be an alignment-controlling material) of the chemical formula (1) were mixed. Further, a polymerization initiator (benzoin isopropyl ether) in an amount of 1 mass % relative to the curable compound 1 was mixed and stirred with heating on a hot stirrer set at 60° C. to obtain a mixture 1.

To prepare one substrate provided with an electrode, an ITO (indium tin oxide) thin film was formed as a transparent electrode on a glass substrate, and the ITO thin film was patterned into a pectinate shape with an electrode width of 5 μm and a distance between electrodes of 5 μm to form a pair of pectinate electrodes. On the electrodes of the glass substrate, an alignment film consisting of a polyimide thin film with a pretilt angle of about 90° was formed. Then, as the other substrate, a glass substrate having only an alignment film consisting of a polyimide thin film with a pretilt angle of about 90° formed thereon was prepared. The above two glass substrates were disposed to face each other via spacer resin beads having a diameter of 6 μm, and the mixture 1 was sandwiched therebetween to obtain a liquid crystal cell.

This liquid crystal cell while kept at 35° C. was irradiated with 3 mW/cm² ultraviolet rays from top and bottom for 10 minutes using a chemical lamp with a dominant wavelength of about 365 nm, to cure the curable compound 1 thereby to obtain a liquid crystal optical device.

After irradiation with ultraviolet rays, the liquid crystal optical device was in a transparent state. Then, a rectangular voltage of 40 V at 200 Hz was applied between the pectinate ITO electrodes as a pair on one glass substrate, whereupon the device was in a scattering state.

The scattering properties between electrodes with a width of 5 μm of the liquid crystal optical device were obtained in such a manner that a light source was set on the back of the device, and a light source brightness of light which was transmitted through the liquid crystal optical device from a transmission state when no voltage was applied to a scattering state when a voltage was applied, was calculated as transmittance data. In a state where the device was in a scattering state when a voltage was applied, an image in a predetermined region was taken by a CCD camera using an optical lens, and from the image data, the correlated brightness level in a 5 μm×20 μm rectangular region located in a region between the electrodes with a width of 5 μm was measured. Measurement was carried out at three portions, and the average was taken for evaluation.

Then, as a reference device, another liquid crystal optical device showing a change from a transmission state to a scattering state by application of voltages at different levels, voltage/transmittance properties were measured by means of Schlieren optical system with a converging angle of 5°. Of the reference device, in the same manner as above, the light source brightness of light which was transmitted through the reference device when voltages at different levels were applied was measured by a brightness measuring apparatus, to determine the voltage/brightness properties. From correlation between the obtained voltage/transmittance properties and voltage/brightness properties, the brightness/transmittance calculation was derived.

Using the liquid crystal optical device of the present invention, the voltage/brightness properties were measured, and from the brightness/transmittance calculation derived from the reference device, the transmittance of only between the pectinate electrodes of the liquid crystal optical device of the present invention was obtained by means of Schlieren optical system with a converging angle of 5°. The transmittance in a transmission state when no voltage was applied was 81%, and the transmittance when a rectangular voltage of 40 V was applied was 15%.

### REFERENCE SYMBOLS

1: Electrooptical functional layer

2: Liquid crystal compound

3: Alignment-controlling material

10: First substrate

11: First alignment functional layer

20: Second substrate

21: Second alignment functional layer

30: Electric field applying means

31: First electrode

32, 37: Connecting portion

33, 38: Pectinate portions

36: Second electrode

100: Liquid crystal optical device

The entire disclosure of Japanese Patent Application No. 2015-115208 filed on Jun. 5, 2015 including specification, claims, drawings and summary is incorporated herein by reference in its entirety.

What is claimed is:

1. A liquid crystal optical device comprising:
a pair of substrates facing each other, at least one of which having transparency to light,
an electrooptical functional layer sandwiched between the substrates, and
an electric field applying means to generate an electric field in the electrooptical functional layer,
wherein the electrooptical functional layer contains a liquid crystal compound having a positive dielectric anisotropy and showing liquid crystallinity, and an alignment-controlling material for controlling the alignment of the liquid crystal compound, and
the electric field applying means is so constituted as to generate an electric field containing lines of electric force substantially in parallel with the substrate surface of at least one of the substrates.

2. The liquid crystal optical device according to claim 1, which is in a transparent state when no voltage is applied and in a state where incident light is scattered when a voltage is applied.

3. The liquid crystal optical device according to claim 1, wherein the alignment-controlling material comprises a polymer structure.

4. The liquid crystal optical device according to claim 1, wherein the electric filed applying means comprises a first electrode and a second electrode formed on at least one of the substrates, and generates the above electric field by applying a voltage between the first and second electrodes.

5. The liquid crystal optical device according to claim 4, wherein each of the first electrode and the second electrode has a plurality of electrode pairs in parallel with each other, and the electrode pairs of the first electrode and the electrode pairs of the second electrode are alternately disposed so that they are in parallel with the substrate surface of the substrate.

6. The liquid crystal optical device according to claim 1, wherein the average direction of long axes of molecules of the liquid crystal compound substantially agrees with the normal direction of the substrate surface of at least one of the substrates when no voltage is applied.

7. The liquid crystal optical device according to claim 1, wherein the alignment-controlling material is a polymer structure containing resin columns at least some of which extend in the normal direction of the substrate surface.

8. The liquid crystal optical device according to claim 1, wherein an alignment functional layer is formed on the outer side of the electrooptical functional layer, and the alignment functional layer is a vertical alignment functional layer.
